(19) United States
(12) Patent Application Publication
(10) Pub. No.: US 2025/0013597 A1
(43) Pub. Date: Jan. 9, 2025

(54) KVM SYSTEM

(71) Applicant: Dietmar PFURTSCHELLER, Tattendorf (AZ)

(72) Inventor: Dietmar PFURTSCHELLER, Tattendorf (AZ)

(21) Appl. No.: 18/573,560

(22) PCT Filed: Jun. 29, 2021
(86) PCT No.: PCT/AT21/60228

§ 371 Date: Sep. 12, 2024

(30) Foreign Application Priority Data
Jun. 25, 2021 (AT) A 50529/2021

(51) Int. Cl. G06F 13/42; G06F 13/38

(52) U.S. Cl. CPC G06F 13/4282; G06F 13/382; G06F 2213/0042

(57) ABSTRACT

A KVM system is expanded in that the remote devices independently set up connections to the USB peripherals and in the process allocate USB addresses: in that provision is made for a management device that stores the USB addresses allocated by the hosts and the USB addresses allocated by the remote devices and assigns a unique identifier to each USB peripheral in the system: in that provision is made, in the management device. for at least one assignment table in which each address allocated by the hosts is assigned the unique identifier of a USB peripheral: in that, when data are transmitted from the USB peripheral to the host, the USB data are manipulated, either in the remote devices or in the local devices, such that the USB addresses allocated by the remote devices are replaced by the USB addresses allocated by the hosts; and in that, when data are transmitted from the host to the USB peripheral. the USB data are manipulated, either in the remote devices or in the local devices, such that the USB addresses allocated by the hosts are replaced by the USB addresses allocated by the remote devices.

### TECHNICAL FIELD

The present invention relates to a KVM system, comprising:
a) a network;
b) multiple remote devices each comprising:
a USB communication interface for communication with at least one USB peripheral device;
a network communication interface for communication with the network;
a processing unit connected to the USB communication interface and the network communication interface for receiving data from the USB peripheral device via the USB communication interface, embedding it into network data packets, and sending it over the network, or conversely, receiving network data packets intended for the respective remote device, extracting the USB data, and sending it to the respective USB peripheral device;
c) multiple local devices each comprising:
a USB communication interface for communication with a USB host;
a network communication interface for communication with the network;
a processing unit connected to the USB communication interface and the network communication interface for receiving network data packets intended for the respective local device via the network communication interface, extracting the USB data, and sending it to the USB host via the USB communication interface, or conversely, receiving data from the USB host via the USB communication interface, embedding it into network data packets, and sending it over the network;
wherein the hosts assign a USB address to each USB peripheral device when establishing a USB connection according to the USB standard.

### STATE OF THE ART

KVM systems are designed to extend the range of USB connections. KVM stands for Keyboard, Video, and Mouse. However, KVM systems are not limited to these devices; any USB peripheral device can be connected to a distant computer (host) via a KVM system.

USB (Universal Serial Bus) is an industry standard defining the cables, connectors, and communication protocols used in a bus for connection, communication, and power supply between computers and electronic peripheral devices. The design architecture of USB is asymmetrical in its topology, consisting of a host, multiple downstream USB ports, and multiple peripherals connected in a tree-like topology.

Up to 255 devices, including hub devices, if present, can be connected to a single host. This limitation arises because each host assigns a unique address to each connected USB peripheral device (known as enumeration), and only one byte (=8 bits) is reserved for this address. With 8 bits, 256 numbers can be encoded, and since address “0” is reserved, 255 addresses remain available for assignment to individual devices.

Due to limitations of the USB standard (e.g., USB 1.1, USB 2.0), a standard USB cable is limited to a length of about 5 meters (for USB 3.0, the limit is even 3 meters). This is due to the specified maximum response times and the signal propagation time in the cable. Thus, USB cables cannot be of arbitrary length.

If, for example, the host computer is in one room and the peripheral devices are in another, more distant room, a direct connection with USB cables is not possible. Here, a KVM system can be used.

The basic idea of a KVM system is as follows: Since most buildings have a network (e.g., realized with Cat-5 cables) where significantly longer cable lengths are permissible, “remote devices” are provided for the USB peripheral devices. These remote devices convert the USB signals of a USB peripheral device into network packets and send them over the network to “local devices” where the USB signals are retrieved from the network packets and transmitted to the host as USB signals. Naturally, the entire process is bidirectional, i.e., data transfer also occurs analogously from the host to the USB peripheral device.

In such a network, each device, including each “remote device” and each “local device,” has a unique IP address. The IP address of the associated local device is stored in each remote device, and the IP address of the associated remote device is stored in each local device, ensuring that data packets are always transferred to the corresponding device. By changing the stored addresses, it is possible to connect a group of peripheral devices (e.g., mouse, keyboard, and monitor) to different hosts. This is particularly beneficial for remote maintenance: the system administrator no longer needs to go to each PC (host) to make changes but can stay at his workstation and connect his peripheral devices to each PC where changes are necessary, one after the other.

A disadvantage of this widely used system is that all peripheral devices connected to a local device can only be switched to another host together.

For this reason, it was proposed in US 2015/254193 A (forming the preamble of claim 1), see especially FIG. 8 and the associated description, paragraphs [0084]-[0107], that the remote devices can store IP addresses of multiple local devices, one for each connected USB peripheral device. Thus, each USB peripheral device can be connected to a different host.

In all known systems, including the one according to the mentioned US 2015/254193 A, each host assigns a USB address to each USB peripheral device when establishing a USB connection according to the USB standard. This inevitably means that when switching a USB peripheral device to another host, a new USB address must be assigned. As anyone who works with USB peripheral devices knows, the recognition and address assignment takes some time, resulting in an annoying waiting period (especially with frequent switching).

Another disadvantage of known systems is that a USB peripheral device can only be connected to one host; if it were connected to multiple hosts, it would most likely have a different USB address for each host, and managing two or more USB addresses in one USB peripheral device is not provided for in the standard.

### DESCRIPTION OF THE INVENTION

The object of the present invention is to eliminate these limitations of the systems according to the prior art.

This object is achieved by a KVM system of the above-described type where the remote devices independently establish connections to the USB peripheral devices and assign USB addresses; a management device is provided that stores the USB addresses assigned by the hosts and the USB addresses assigned by the remote devices, and assigns a unique identifier to each USB peripheral device in the system; at least one mapping table is provided in the management device in which each address assigned by the hosts is mapped to the unique identifier of a USB peripheral device; during data transmission from the USB peripheral device to the host, the USB data is manipulated either in the remote devices or in the local devices such that the USB addresses assigned by the remote devices are replaced by the USB addresses assigned by the hosts; and, during data transmission from the host to the USB peripheral device, the USB data is manipulated either in the remote devices or in the local devices such that the USB addresses assigned by the hosts are replaced by the USB addresses assigned by the remote devices.

Previously, USB data was embedded in network data packets, transmitted over the network, then extracted and passed on essentially unchanged. According to the invention, the USB signals are modified in that the USB address is now manipulated. The USB peripheral device does not “learn” the address assigned by the host (only the local device learns this), but receives its own USB address assigned by its remote device, independently of the host. Thus, the USB peripheral device can be switched away from one host and connected to another host without the USB peripheral device “noticing” it, and the host also does not “notice” when the USB peripheral device is temporarily switched away. This makes switching more or less instantaneous, and no time is needed to assign USB addresses. In a manner of speaking, all USB peripheral devices remain virtually connected to the host at all times.

Another advantage is that with the solution according to the invention, a USB peripheral device can be connected to multiple hosts, which can be practical, for example, for keyboards. In a company network, it is possible to input the same update command on several identically configured PCs using one keyboard. This is made possible because the USB peripheral device always uses the same USB address for communication, which is translated into the respective USB addresses assigned by the hosts. Furthermore, all affected PCs can read the necessary update files from one USB peripheral device without having to distribute these update files over the company network beforehand.

Finally, it is also possible to use more than 255 USB peripheral devices in the overall system.

The described features of the invention are also necessary when only data from the USB peripheral device to the host is ultimately transmitted, such as with keyboards and mice, because USB communication is always bidirectional.

A particular advantage of the system according to the invention is that no changes are necessary on the hosts or the USB peripheral devices; no additional drivers or other software are required. Thus, the product liability of the hardware and software manufacturers remains intact.

According to one embodiment of the present invention, each USB peripheral device is associated with an information unit that specifies whether it is included in the mapping table(s). If a USB peripheral device does not appear in the mapping table, it is only visible to the management device (“hidden devices”). Such “hidden devices,” mainly intended for keyboards, are used to control the management device. For example, if a new USB peripheral device is connected to one of the remote devices, it can be specified with which local device it should communicate, i.e., the entry in the mapping table is configured.

It is particularly advantageous if multiple preconfigured mapping tables are provided in the management device, between which switching can occur. For switching, a “hidden device,” such as a numeric keypad, can be used, where each digit is assigned to a mapping table that is activated when the corresponding key is pressed.

### BEST WAY OF CARRYING OUT THE INVENTION

The function of the inventive KVM system is explained in more detail below.

The local device at the PC transmits all USB data traffic between the host (PC) and the USB peripheral devices to the remote devices. As a result, the processing unit in the local device can manipulate each individual USB data packet and send it to various endpoints in the switching network.

A computer manages directly connected USB peripheral devices as follows: after plugging in, a reset is performed, and the USB address is then 0. The host assigns a valid USB address to this device (in the range of 1-255). This process is called enumeration.

According to the present invention, the real USB peripheral device does not receive its USB address from a host but from the associated remote device, which simulates a host in this regard. Thus, no change is necessary on the USB peripheral device.

On the other hand, according to the present invention, the hosts assign USB addresses as usual, but the real USB peripheral device does not “learn” this; it is intercepted by the local device. Therefore, no changes are necessary on the hosts, which is particularly crucial in security-sensitive environments (such as banks) because, in such environments, every device must undergo all security checks again after any change, which is costly. Thus, this communication from the hosts does not take place with the real USB peripheral device but with the local device.

The entire system is controlled by a so-called management device, hereinafter referred to as the “Switching Manager” (SM).

The SM communicates with all local and remote devices and creates a mapping table, which is also sent to the respective local and remote devices whenever a change occurs, such as when switching a USB peripheral device.

The local device can then send data packets to the assigned remote device and thus to the desired USB peripheral device.

When the system is set up, the SM scans all remote devices and queries the connected USB peripheral devices. It also scans all local devices. The data is entered into the mapping table, and the administrator can then assign the devices or change them later.

The mapping table contains the following entries for each real USB peripheral device:
IP address of the remote device [xxx.xxx.xxx.xxx]
USB address [1-255]
HUB USB address [1-255]
HUB port number where the USB peripheral device is connected [1-8]

These four values form a unique identifier for each USB peripheral device. If no hub is used, the last two values can, of course, be omitted. This creates the columns of the mapping table.

The rows of the mapping table are formed by the “virtual” USB peripheral devices connected to each PC. The IP address of the local device and the USB address of the virtual USB peripheral device are entered. At the intersection of the row of the virtual USB peripheral device and the column of the real USB peripheral device, for example, “1” is entered if the virtual USB peripheral device corresponds to the real USB peripheral device, and “0” otherwise.

This table is transmitted to all local devices and all remote devices, where it is sufficient to transmit only the part relevant to the respective device: for each local device, only those rows where the IP address matches are transmitted, and for each remote device, only those columns where the IP address matches are transmitted.

If a host issues a USB command, it is received by the local device; the local device determines, based on the virtual USB address and the mapping table, to which USB peripheral device the command must be transmitted, and thus learns the IP address and the real USB address. It replaces the virtual USB address with the real USB address and transmits the modified USB command in a data packet over the network to the corresponding IP address, the data packet including the HUB USB address and HUB port number, if applicable. The remote device with this IP address receives the packet, decodes it, and thus knows to which real USB peripheral device the USB command must be transmitted. The USB peripheral device then receives the USB command with the correct USB address.

In the reverse direction, when a USB peripheral device sends USB data, the system works analogously: the USB data is received by the remote device; the remote device determines, based on the real USB address and the mapping table, to which host the data must be transmitted, and thus learns the IP address and the virtual USB address. It replaces the real USB address with the virtual USB address and transmits the modified USB data in a data packet over the network to the corresponding IP address. The local device with this IP address receives the packet, decodes it, and transmits it to the host. The host can then, based on the virtual USB address, determine from which USB peripheral device the data originates.

1. A KVM system, comprising:
a) a network;
b) multiple remote devices each having
a USB communication interface for communication with a USB peripheral device;
a network communication interface for communication with the network;
a processing unit connected to the USB communication interface and the network communication interface for receiving data from the USB peripheral device via the USB communication interface, embedding it into network data packets, and sending it over the network, or conversely, receiving network data packets intended for the respective remote device, extracting the USB data, and sending it to the respective USB peripheral device;
c) multiple local devices each having:
a USB communication interface for communication with a USB host;
a network communication interface for communication with the network;
a processing unit connected to the USB communication interface and the network communication interface for receiving network data packets intended for the respective local device via the network communication interface, extracting the USB data, and sending it to the USB host via the USB communication interface, or conversely, receiving data from the USB host via the USB communication interface, embedding it into network data packets, and sending it over the network;
wherein
the hosts assign a USB address to each USB peripheral device when establishing a USB connection according to the USB standard,
the remote devices independently establish connections to the USB peripheral devices and assign USB addresses;
a management device is provided which stores the USB addresses assigned by the hosts and the USB addresses assigned by the remote devices and assigns a unique identifier to each USB peripheral device in the system;
at least one mapping table is provided in the management device, in which each address assigned by the hosts is mapped to the unique identifier of a USB peripheral device;
during data transmission from the USB peripheral device to the host, the USB data is manipulated either in the remote devices or in the local devices such that the USB addresses assigned by the remote devices are replaced by the USB addresses assigned by the hosts; and
during data transmission from the host to the USB peripheral device, the USB data is manipulated either in the remote devices or in the local devices such that the USB addresses assigned by the hosts are replaced by the USB addresses assigned by the remote devices.

2. The KVM system according to claim 1, wherein each USB peripheral device is associated with a n respective information unit that specifies whether it is included in the mapping table(s).

3. The KVM system according to claim 1, wherein multiple preconfigured mapping tables are provided in the management device, between which switching can occur.
